(19) United States
(12) Patent Application Publication
(10) Pub. No.: US 2026/0081371 A1
(43) Pub. Date: Mar. 19, 2026

(54) TERMINAL BLOCK

(71) Applicant: Cheng Uei Precision Industry Co., Ltd., New Taipei City (TW)

(72) Inventors: Chuan Hung Lin, New Taipei City (TW); Sheng Nan Yu, New Taipei City (TW)

(21) Appl. No.: 19/049,080

(22) Filed: Feb. 10, 2025

(30) Foreign Application Priority Data
Sep. 16, 2024 (CN) 202422265799.9

(51) Int. Cl. H01R 9/24

(52) U.S. Cl. CPC H01R 9/2416

(57) ABSTRACT

A terminal block includes an insulating housing, a movable element disposed to a rear end of the insulating housing, a crimping terminal, a first signal terminal, a second signal terminal and a circuit board. The insulating housing has a front terminal slot, a rear terminal slot and a bottom portion. The crimping terminal is disposed in the front terminal slot. The crimping terminal has a first soldering portion. The first signal terminal disposed in the rear terminal slot has a first fastening portion. A bottom end of the first fastening portion extends downward to form a second soldering portion. The second signal terminal disposed in the rear terminal slot has a second fastening portion. A bottom end of the second fastening portion extends downward to form a third soldering portion. The circuit board is disposed to a bottom surface of the insulating housing.

### CROSS REFERENCE TO RELATED APPLICATIONS

The present application is based on, and claims priority from, China Patent Application No. 202422265799.9, filed Sep. 16, 2024, the disclosure of which is hereby incorporated by reference herein in its entirety.

### BACKGROUND OF THE INVENTION

### Field of the Invention

The present invention generally relates to a terminal block, and more particularly to a terminal block which prevents a soldering flux from contaminating a contacting portion of the terminal block in a soldering process of the terminal block.

### Description of Related Art

Generally, a terminal block is an electrical connector which is used for electrically connecting to a wire of a circuit component. After the wire of the circuit component is inserted into the terminal block, a wire inserting hole of a metal clamping piece of the terminal block shrinks to compress the wire, so that the wire is clamped in the wire inserting hole to realize an electrical connection between the circuit component and the terminal block.

A conventional terminal block includes a base body, a movable element, a metal elastic element, a first signal terminal and a second signal terminal. The base body has a first receiving groove and a second receiving groove. One end of the movable element has an abutting part. The other end of the movable element has two rotating arms. The two rotating arms are connected with two opposite sides of the base body. The metal elastic element is disposed in the first receiving groove. One end of the metal elastic element has two first abutting portions. The first signal terminal is disposed in the second receiving groove. One end of the first signal terminal has a first contacting portion and a second abutting portion. The second signal terminal is disposed in the second receiving groove. One end of the second signal terminal has a second contacting portion. The second contacting portion contacts with the first contacting portion to form a signal circuit. When the movable element is pressed, the movable element drives the two first abutting portions to move, the abutting part drives the second abutting portion to move, and the first contacting portion moves away from the second contacting portion. The signal circuit remains in an open circuit state.

However, the base body of the conventional terminal block is close to a base board. In a soldering process of the conventional terminal block, soldering tin of the base board passes through a reflow oven, a soldering flux is released. The soldering flux flows to the first contacting portion along the first signal terminal or the soldering flux flows to the second contacting portion along the second signal terminal, a conductive function of the first signal terminal or a conductive function of the second signal terminal is affected.

Thus, it is essential to provide an innovative terminal block, the innovative terminal block prevents the soldering flux from contaminating a contacting portion of the innovative terminal block in a soldering process of the innovative terminal block.

### BRIEF SUMMARY OF THE INVENTION

An object of the present invention is to provide a terminal block which prevents a soldering flux from contaminating a contacting portion of the terminal block in a soldering process of the terminal block. The terminal block includes an insulating housing, a movable element disposed to a rear end of the insulating housing, a crimping terminal, a first signal terminal, a second signal terminal and a circuit board. The insulating housing has a front terminal slot, a rear terminal slot and a bottom portion. The bottom portion of the insulating housing has a plurality of inserting slots. The plurality of the inserting slots are communicated with the front terminal slot and the rear terminal slot, respectively. The crimping terminal is disposed in the front terminal slot. The crimping terminal has a first soldering portion. The first soldering portion extends out of the inserting slot which is communicated with the front terminal slot. The first signal terminal is disposed in the rear terminal slot. The first signal terminal is disposed to a rear of the crimping terminal. The first signal terminal has a first fastening portion. A top end of the first fastening portion extends rearward to form a first contacting portion. A bottom end of the first fastening portion extends downward to form a second soldering portion. The second soldering portion extends out of one inserting slot which is communicated with the rear terminal slot. The second signal terminal is disposed in the rear terminal slot. The second signal terminal is disposed to a rear of the first signal terminal. The second signal terminal has a second fastening portion. A top end of the second fastening portion is bent frontward to form a second bending portion. The second bending portion extends downward to form a second contacting portion. A front surface of the second contacting portion extends frontward to form a protruding portion. The protruding portion contacts with the first contacting portion. An inner space is formed between a rear surface of the second contacting portion and a rear surface of the protruding portion. A bottom end of the second fastening portion extends downward to form a third soldering portion. The third soldering portion extends out of the other inserting slot which is communicated with the rear terminal slot. The circuit board is disposed to a bottom surface of the insulating housing. The circuit board has a plurality of through holes penetrating through a top surface and a bottom surface of the circuit board. The first soldering portion, the second soldering portion and the third soldering portion are inserted into the plurality of the through holes separately.

Another object of the present invention is to provide a terminal block. The terminal block includes an insulating housing, a crimping terminal, at least one second signal terminal. The insulating housing has a bottom portion. The bottom portion has at least one inserting slot which penetrates through the bottom portion. The crimping terminal is disposed in the insulating housing. The at least one signal terminal is disposed in the insulating housing. The signal terminal is disposed to a rear of the crimping terminal. The signal terminal has a fastening portion, a bending portion, a contacting portion and a soldering portion. The fastening portion is disposed to the inserting slot. The soldering portion extends out of the inserting slot. The signal terminal has an aperture penetrating through a front surface and a rear surface of the fastening portion. The insulating housing has at least one of a notch and an accommodating space which are communicated with the aperture. The notch is formed in a front wall of the inserting slot. The accommodating space is formed in a rear wall of the inserting slot.

Another object of the present invention is to provide a terminal block. The terminal block includes an insulating housing, a movable element disposed to a rear end of the insulating housing, a crimping terminal, a first signal terminal, a second signal terminal and a circuit board. The insulating housing has a front terminal slot, a rear terminal slot and a bottom portion. The bottom portion has a first inserting slot, a second inserting slot and a third inserting slot which penetrate through a bottom surface of the bottom portion. The front terminal slot is communicated with the first inserting slot. The rear terminal slot is communicated with the second inserting slot and the third inserting slot. The crimping terminal is disposed in the front terminal slot. The crimping terminal has a base portion. A rear end of the base portion extends downward to form a first soldering portion. The base portion is disposed in the first inserting slot. The first soldering portion extends out of the first inserting slot. The first signal terminal is disposed in the rear terminal slot. The first signal terminal is disposed to a rear of the crimping terminal. The first signal terminal has a first fastening portion. A top end of the first fastening portion extends rearward to form a first contacting portion. A bottom end of the first fastening portion extends downward to form a second soldering portion. The first contacting portion is disposed in the rear terminal slot. The second soldering portion extends out of the second inserting slot. The second signal terminal is disposed in the rear terminal slot. The second signal terminal is disposed to a rear of the first signal terminal. The second signal terminal has a second fastening portion. A top end of the second fastening portion is bent frontward to form a second bending portion. The second bending portion extends downward to form a second contacting portion. A front surface of the second contacting portion extends frontward to form a protruding portion. The protruding portion contacts with the first contacting portion. A perforation penetrates through middles of a top surface and a bottom surface of the second bending portion. The perforation is corresponding to the protruding portion. A bottom end of the second fastening portion extends downward to form a third soldering portion. The third soldering portion extends out of the third inserting slot. The circuit board is disposed to a bottom surface of the insulating housing.

As described above, the top end of the second fastening portion is bent frontward to form the second bending portion, and the second bending portion is used for increasing a distance between the second contacting portion and the third soldering portion. The front surface of the second contacting portion extends frontward to form the protruding portion, the inner space of the protruding portion of the second signal terminal is used for increasing a rear space of the second contacting portion, and the protruding portion is used for receiving a soldering flux. The bottom portion of the insulating housing, a rear portion of the insulating housing, a limiting portion of the insulating housing and the second fastening portion of the second signal terminal together surround the accommodating space, and the accommodating space is used for increasing a storage space of the soldering flux and reducing a climbing height of the soldering flux. The aperture penetrates through the front surface and the rear surface of the second fastening portion. The aperture is corresponding to the accommodating space and the notch. The aperture is communicated with the accommodating space and the notch. The aperture and the notch of the insulating housing are used for increasing the storage space of the soldering flux and reducing the climbing height of the soldering flux. The perforation penetrates through the middles of the top surface and the bottom surface of the second bending portion. The perforation is used for preventing the soldering flux flowing between the first contacting portion of the first signal terminal and the protruding portion of the second signal terminal. A first stepping portion of a stepping portion of the insulating housing, a second stepping portion of the stepping portion of the insulating housing, the second bending portion of the second signal terminal, the second contacting portion of the second signal terminal and the inner space of the protruding portion of the second signal terminal together form an avoiding space. The soldering flux climbs along the rear surface of the second contacting portion by the avoiding space. As a result, the terminal block prevents the soldering flux from contaminating a contacting portion of the terminal block in a soldering process of the terminal block.

### BRIEF DESCRIPTION OF THE DRAWINGS

The present invention will be apparent to those skilled in the art by reading the following description, with reference to the attached drawings, in which:

FIG. 1 is a perspective view of a terminal block in accordance with a preferred embodiment of the present invention;

FIG. 2 is an exploded view of the terminal block of FIG. 1;

FIG. 3 is a partially perspective view of the terminal block of FIG. 2;

FIG. 4 is an enlarged view of an encircled portion IV of the terminal block of FIG. 3;

FIG. 5 is an exploded view of an insulating housing of the terminal block of FIG. 1;

FIG. 6 is a perspective view of a shell of the insulating housing of the terminal block of FIG. 5;

FIG. 7 is a perspective view of a crimping terminal of the terminal block of FIG. 2;

FIG. 8 is a perspective view of a first signal terminal of the terminal block of FIG. 2;

FIG. 9 is another perspective view of the first signal terminal of the terminal block of FIG. 2;

FIG. 10 is a perspective view of a second signal terminal of the terminal block of FIG. 2; and

FIG. 11 is another perspective view of the second signal terminal of the terminal block of FIG. 2.

### DETAILED DESCRIPTION OF THE INVENTION

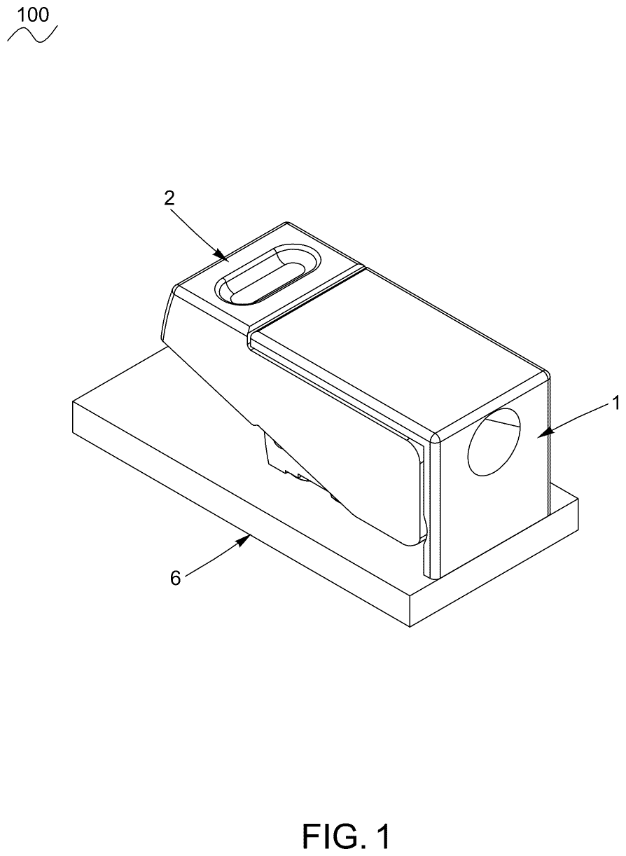

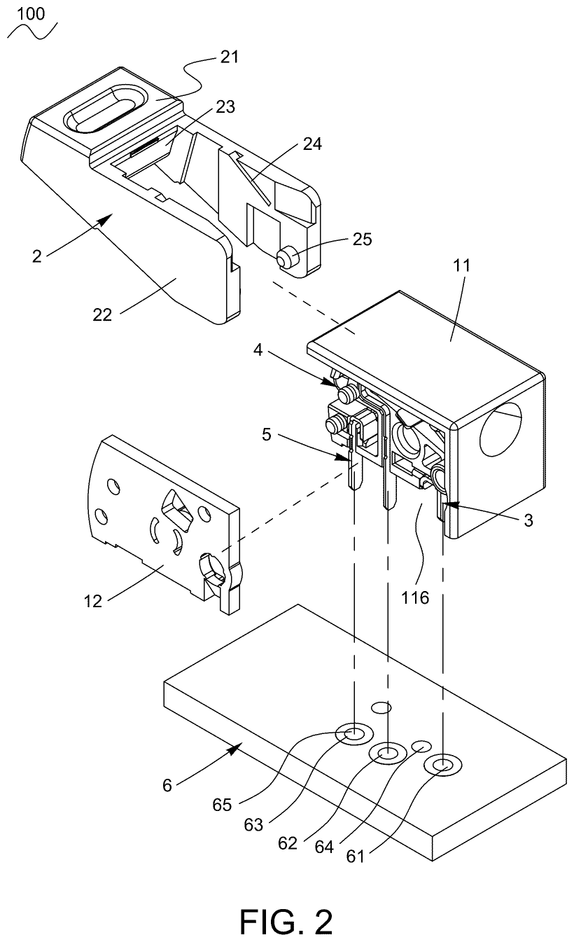

With reference to FIG. 1 and FIG. 2, a terminal block 100 in accordance with a preferred embodiment of the present invention is shown. The terminal block 100 includes an insulating housing 1, a movable element 2, a crimping terminal 3, a first signal terminal 4, a second signal terminal 5 and a circuit board 6. The movable element 2 is disposed to a rear end of the insulating housing 1. The crimping terminal 3, the first signal terminal 4 and the second signal terminal 5 are disposed in the insulating housing 1. The crimping terminal 3 is disposed in an inside of a front end of the insulating housing 1. The first signal terminal 4 is disposed to a rear of the crimping terminal 3. The first signal terminal 4 is disposed in an inside of a middle of the insulating housing 1 and an upper portion of an inside of the rear end of the insulating housing 1. The second signal terminal 5 is disposed to a rear of the first signal terminal 4. The second signal terminal 5 is disposed in a lower portion of the inside of the rear end of the insulating housing 1. The circuit board 6 is disposed to a bottom surface of the insulating housing 1.

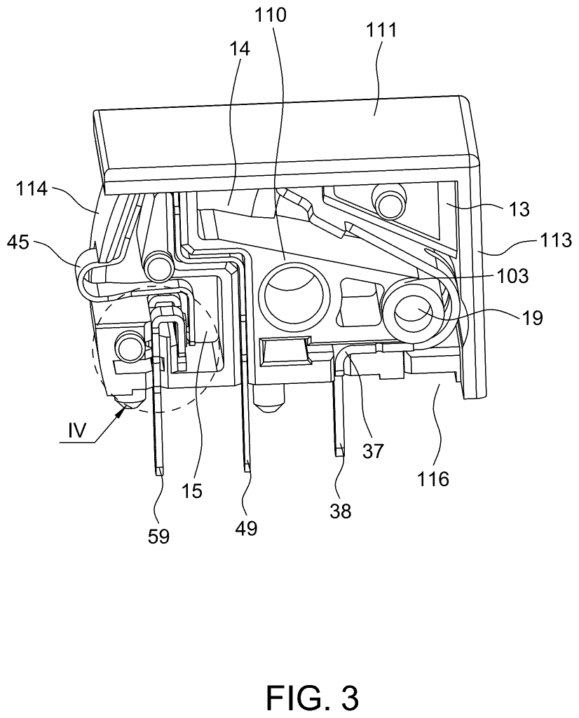

Referring to FIG. 2 to FIG. 6, the insulating housing 1 has a shell 11 and a side cover 12. The side cover 12 is disposed to one side of the shell 11. The shell 11 has a main body 110, a top portion 111, a bottom portion 112, a front portion 113, a rear portion 114, a side portion 115, an opening 116, a first location hole 117, a plurality of assembling holes 118, a plurality of first location pillars 119, a wire slot 13, a front terminal slot 14, a rear terminal slot 15, a limiting portion 16, a stepping portion 17, a gap 18 and two pivoting holes 19. An upper portion of the main body 110 is defined as the top portion 111. A lower portion of the main body 110 is defined as the bottom portion 112. The top portion 111 is corresponding to the bottom portion 112. The front portion 113 and the rear portion 114 are disposed to a front end and a rear end of the top portion 111, respectively. The front portion 113 and the rear portion 114 are disposed to a front end and a rear end of the bottom portion 112, respectively. One side of the main body 110 is defined as the side portion 115. The other side of the main body 110 is defined as the opening 116. The side portion 115 is connected between the front portion 113 and the rear portion 114. The opening 116 is formed between the front portion 113 and the rear portion 114. The side cover 12 is disposed to a side of the opening 116. The side cover 12 covers the opening 116.

A middle of the main body 110 of the shell 11 has the first location hole 117 transversely penetrating through two opposite sides of the main body 110. The first location hole 117 transversely penetrates through two opposite sides of the side portion 115. The first location hole 117 is communicated with the opening 116. A corresponding mechanism of the side cover 12 is fastened in the first location hole 117 of the shell 11 of the insulating housing 1 to realize that the side cover 12 is located to the shell 11, and that the side cover 12 is fastened to the shell 11. The plurality of the assembling holes 118 transversely penetrate through the two opposite sides of the main body 110. The plurality of the assembling holes 118 transversely penetrate through the two opposite sides of the side portion 115. Corresponding mechanisms of the crimping terminal 3, the first signal terminal 4 and the second signal terminal 5 are fastened in the plurality of the assembling holes 118 of the shell 11 of the insulating housing 1 to realize that the crimping terminal 3, the first signal terminal 4 and the second signal terminal 5 are located to the insulating housing 1, and that the crimping terminal 3, the first signal terminal 4 and the second signal terminal 5 are fastened to the insulating housing 1.

The one side of the main body 110 of the shell 11 of the insulating housing 1 extends towards the opening 116 of the shell 11 to form the plurality of the first location pillars 119. The plurality of the first location pillars 119 of the shell 11 of the insulating housing 1 are fastened to a corresponding area of the side cover 12 to realize that the side cover 12 is located to the shell 11, and that the side cover 12 is fastened to the shell 11.

The main body 110 of the shell 11 of the insulating housing 1 has a penetrating groove 121 penetrating through the two opposite sides of the main body 110 of the shell 11 of the insulating housing 1. The penetrating groove 121 penetrates through the two opposite sides of the side portion 115 of the shell 11 of the insulating housing 1. The penetrating groove 121 of the main body 110 of the shell 11 is located above the first location hole 117 of the shell 11 of the insulating housing 1. A corresponding section of the crimping terminal 3 is disposed to the penetrating groove 121 of the main body 110 of the shell 11 of the insulating housing 1. The side cover 12 of the insulating housing 1 has the penetrating groove 121. The penetrating groove 121 penetrates through two opposite sides of the side cover 12.

The wire slot 13 of the shell 11 of the insulating housing 1 is formed between a front end of a bottom surface of the top portion 111 of the shell 11 of the insulating housing 1 and a top end of an inner surface of the front portion 113 of the shell 11 of the insulating housing 1. The front portion 113 of the shell 11 of the insulating housing 1 has a passage hole 1131 penetrating through a front surface and a rear surface of the front portion 113 of the shell 11 of the insulating housing 1. The passage hole 1131 is communicated with the wire slot 13 of the shell 11 of the insulating housing 1.

The front terminal slot 14 of the shell 11 of the insulating housing 1 is formed between the top portion 111 of the shell 11 of the insulating housing 1, the bottom portion 112 of the shell 11 of the insulating housing 1 and the front portion 113 of the shell 11 of the insulating housing 1. The front terminal slot 14 is shown as a substantially V shape. The wire slot 13 of the shell 11 of the insulating housing 1 is communicated with the front terminal slot 14 of the shell 11 of the insulating housing 1. The crimping terminal 3 is disposed in the front terminal slot 14 of the shell 11 of the insulating housing 1. The rear terminal slot 15 of the shell 11 of the insulating housing 1 is formed between the top portion 111 of the shell 11 of the insulating housing 1, the bottom portion 112 of the shell 11 of the insulating housing 1 and the rear portion 114 of the shell 11 of the insulating housing 1. The first signal terminal 4 and the second signal terminal 5 are disposed in the rear terminal slot 15 of the shell 11 of the insulating housing 1.

The bottom portion 112 of the shell 11 of the insulating housing 1 has a concave portion 1120, a first inserting slot 1121, a second inserting slot 1122, a third inserting slot 1123 and at least one third location pillar 1124. The first inserting slot 1121, the second inserting slot 1122 and the third inserting slot 1123 penetrate through a bottom surface of the bottom portion 112 of the insulating housing 1. In the preferred embodiment, the bottom portion 112 of the shell 11 of the insulating housing 1 has two third location pillars 1124. An outer surface of the bottom portion 112 of the shell 11 of the insulating housing 1 is recessed towards the side portion 115 of the shell 11 of the insulating housing 1 to form the concave portion 1120. A corresponding segment of the side cover 12 of the insulating housing 1 is fastened to the concave portion 1120 to realize that the side cover 12 is located to the shell 11, and that the side cover 12 is fastened to the shell 11.

The first inserting slot 1121 penetrates through a top surface and the bottom surface of the bottom portion 112 of the shell 11 of the insulating housing 1. The crimping terminal 3 is corresponding to the first inserting slot 1121. The front terminal slot 14 of the shell 11 of the insulating housing 1 is communicated with the first inserting slot 1121. The crimping terminal 3 is disposed in the first inserting slot 1121. The crimping terminal 3 extends out of the first inserting slot 1121. The crimping terminal 3 projects beyond the bottom surface of the bottom portion 112 of the shell 11. The second inserting slot 1122 penetrates through the top surface and the bottom surface of the bottom portion 112 of the shell 11 of the insulating housing 1. The first signal terminal 4 is corresponding to the second inserting slot 1122. The first signal terminal 4 is disposed in the second inserting slot 1122. The first signal terminal 4 extends out of the second inserting slot 1122. The first signal terminal 4 projects beyond the bottom surface of the bottom portion 112 of the shell 11. The third inserting slot 1123 penetrates through the top surface and the bottom surface of the bottom portion 112 of the shell 11 of the insulating housing 1.

The second signal terminal 5 is corresponding to the third inserting slot 1123. The second signal terminal 5 is disposed in the third inserting slot 1123. The second signal terminal 5 extends out of the third inserting slot 1123. The second signal terminal 5 projects beyond the bottom surface of the bottom portion 112 of the shell 11. The second inserting slot 1122 is located between the first inserting slot 1121 and the third inserting slot 1123. The rear terminal slot 15 of the shell 11 of the insulating housing 1 is communicated with the second inserting slot 1122 and the third inserting slot 1123. In the preferred embodiment, the first inserting slot 1121, the second inserting slot 1122, the third inserting slot 1123 together form a plurality of inserting slots 1125. The bottom portion 112 of the shell 11 of the insulating housing 1 has the plurality of the inserting slots 1125. The plurality of the inserting slots 1125 are communicated with a bottom of the front terminal slot 14 and the rear terminal slot 15. The plurality of the inserting slots 1125 include the first inserting slot 1121, the second inserting slot 1122 and the third inserting slot 1123.

Two portions of the bottom surface of the bottom portion 112 of the shell 11 of the insulating housing 1 extend downward to form the two third location pillars 1124. The two third location pillars 1124 are fastened to a corresponding mechanism of the circuit board 6 to realize that the insulating housing 1 is located to the circuit board 6, and that the insulating housing 1 is fastened to the circuit board 6.

The shell 11 of the insulating housing 1 has a rear hole 1141 penetrates through an outer surface of the rear portion 114 opposite to the side portion 115, a front surface of the rear portion 114 and a rear surface of the rear portion 114 of the shell 11 of the insulating housing 1. A corresponding mechanism of the first signal terminal 4 is disposed to the rear hole 1141. A lower portion of the rear portion 114 of the shell 11 of the insulating housing 1 extends frontward to form the limiting portion 16. The limiting portion 16 of the shell 11 of the insulating housing 1 is located below the rear hole 1141. A middle of a front surface of the limiting portion 16 of the shell 11 of the insulating housing 1 is recessed rearward to form a limiting groove 161. The limiting groove 161 is used for restricting a position of the second signal terminal 5. The limiting groove 161 increases a storage space of a soldering flux, and the limiting groove 161 reduces a climbing height of the soldering flux. A corresponding mechanism of the second signal terminal 5 is fastened in the limiting groove 161 to realize that the second signal terminal 5 is located to the insulating housing 1, and that the second signal terminal 5 is fastened to the insulating housing 1.

A rear of the top surface of the bottom portion 112 of the shell 11 of the insulating housing 1 extends upward to form the stepping portion 17. The stepping portion 17 is located between the rear terminal slot 15 and the limiting groove 161. The stepping portion 17 has a first stepping portion 171, a second stepping portion 172 and a third stepping portion 173. The rear of the top surface of the bottom portion 112 of the shell 11 of the insulating housing 1 extends upward to form the first stepping portion 171, the second stepping portion 172 and the third stepping portion 173 in sequence. The rear of the top surface of the bottom portion 112 of the shell 11 of the insulating housing 1 extends upward to form the first stepping portion 171. A lower portion of a front surface of the first stepping portion 171 extends frontward to form the second stepping portion 172. A lower portion of a front surface of the second stepping portion 172 extends frontward to form the third stepping portion 173.

The second stepping portion 172 is disposed to a front end of the first stepping portion 171. The third stepping portion 173 is disposed to a front end of the second stepping portion 172. The first stepping portion 171 and the second stepping portion 172 are clamped by the second signal terminal 5. A bottom surface of a front end of the second signal terminal 5 abuts against a top surface of the third stepping portion 173. In the preferred embodiment, a height of the first stepping portion 171 is higher than a height of the second stepping portion 172, and the height of the second stepping portion 172 is higher than a height of the third stepping portion 173. A rear surface of the first stepping portion 171 is recessed frontward to form a notch 174. The notch 174 is used for increasing the storage space of the soldering flux and reducing the climbing height of the soldering flux.

The front surface of the limiting portion 16 is spaced from the rear surface of the first stepping portion 171. The gap 18 of the shell 11 of the insulating housing 1 is formed between the front surface of the limiting portion 16 of the shell 11 of the insulating housing 1 and the rear surface of the first stepping portion 171 of the stepping portion 17 of the shell 11 of the insulating housing 1. The gap 18 is disposed to a top of the third inserting slot 1123. The gap 18 of the shell 11 of the insulating housing 1 is communicated with the third inserting slot 1123 of the bottom portion 112 of the shell 11 of the insulating housing 1. The second signal terminal 5 is disposed to the gap 18 of the shell 11 of the insulating housing 1. The second signal terminal 5 extends out of the gap 18 of the shell 11 of the insulating housing 1. A top end of the second signal terminal 5 extends out of a top of the gap 18. A bottom end of the second signal terminal 5 extends out of a bottom of the gap 18, and the bottom end of the second signal terminal 5 projects out of a bottom of the third inserting slot 1123. A front end of an outer surface of the main body 110 of the shell 11 of the insulating housing 1 protrudes outward and opposite to the side portion 115 to form a cylindrical portion 103. A middle of the cylindrical portion 103 is recessed inward to form one pivoting hole 19. A front end of an outer surface of the side portion 115 of the shell 11 of the insulating housing 1 is recessed inward to form the other pivoting hole 19. Two corresponding mechanisms of the movable element 2 are disposed in the two pivoting holes 19.

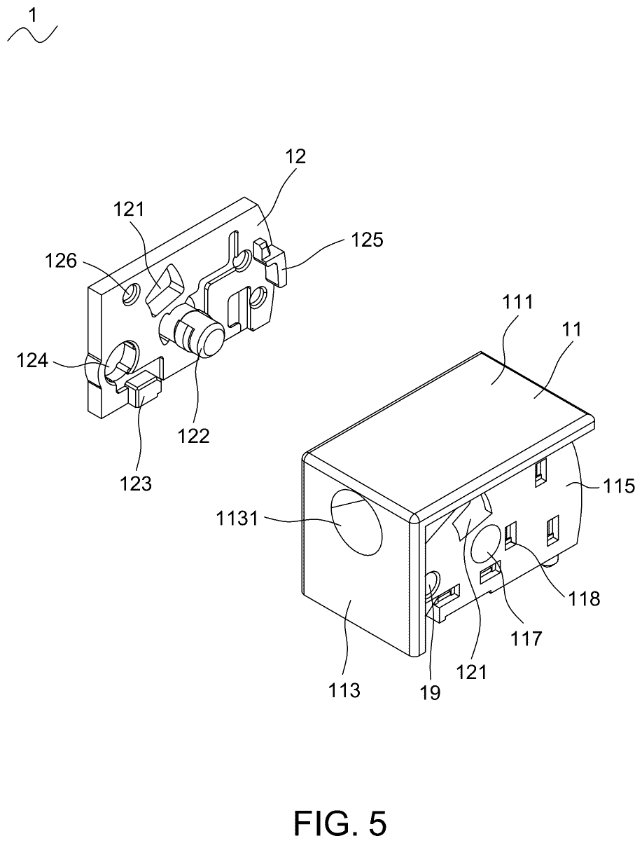

Referring to FIG. 5, the side cover 12 of the insulating housing 1 has the penetrating groove 121, a second location pillar 122, a first protrusion 123, a penetrating hole 124, a second protrusion 125 and a plurality of second location holes 126. The penetrating groove 121 penetrates through the two opposite sides of the side cover 12 of the insulating housing 1. The penetrating groove 121 of the shell 11 of the insulating housing 1 is corresponding to the penetrating groove 121 of the side cover 12 of the insulating housing 1. Two corresponding structures of the crimping terminal 3 are disposed to the penetrating groove 121 of the shell 11 of the insulating housing 1 and the penetrating groove 121 of the side cover 12 of the insulating housing 1.

A middle of one side surface of the side cover 12 extends towards the main body 110 of the shell 11 of the insulating housing 1 to form the second location pillar 122. The penetrating groove 121 of the side cover 12 of the insulating housing 1 is located above the second location pillar 122. The second location pillar 122 is fastened in the first location hole 117 of the shell 11 of the insulating housing 1 to realize that the side cover 12 is located to the shell 11, and that the side cover 12 is fastened to the shell 11. A bottom end of a front end of the one side surface of the side cover 12 extends towards the main body 110 of the shell 11 of the insulating housing 1 to form the first protrusion 123. The first protrusion 123 is fastened in the concave portion 1120 of the bottom portion 112 of the shell 11 of the insulating housing 1 to realize that the side cover 12 is located to the shell 11, and that the side cover 12 is fastened to the shell 11.

The penetrating hole 124 penetrates through two front ends of the two opposite sides of the side cover 12. The penetrating hole 124 is located above the first protrusion 123. The penetrating hole 124 is mounted around the cylindrical portion 103 together with the one pivoting hole 19 of the shell 11 of the insulating housing 1. A rear end of the one side surface of the side cover 12 extends towards the main body 110 of the shell 11 of the insulating housing 1 to form the second protrusion 125. The second protrusion 125 is fastened in the rear hole 1141 of the rear portion 114 of the shell 11 of the insulating housing 1 to realize that the side cover 12 is located to the shell 11, and that the side cover 12 is fastened to the shell 11. The plurality of the second location holes 126 transversely penetrate through the two opposite sides of the side cover 12. The plurality of the first location pillars 119 of the shell 11 of the insulating housing 1 are fastened to the plurality of the second location holes 126 to realize that the side cover 12 is located to the shell 11, and that the side cover 12 is fastened to the shell 11.

Referring to FIG. 2 to FIG. 5, the movable element 2 is movably connected to the rear end of the insulating housing 1. The movable element 2 has a pressing portion 21, two extending arms 22, a protrusion block 23, two fastening grooves 24 and two pivoting portions 25. Two opposite sides of a front end of the pressing portion 21 extend frontward to form the two extending arms 22, respectively. The two extending arms 22 are disposed to the outer surface of the side portion 115 of the shell 11 of the insulating housing 1 and an outer surface of the side cover 12 of the insulating housing 1. A junction between the pressing portion 21 and one extending arm 22 and a junction between the pressing portion 21 and the other extending arm 22 extend towards each other and then extend downward to form the protrusion block 23. The protrusion block 23 is used for pressing a corresponding part of the first signal terminal 4.

Middles of inner surfaces of the two extending arms 22 are slantwise recessed oppositely to form the two fastening grooves 24 penetrating through two top surfaces of the two extending arms 22. The two fastening grooves 24 extend downward and frontward. The two fastening grooves 24 are corresponding to the penetrating groove 121 of the main body 110 of the shell 11 of the insulating housing 1 and the penetrating groove 121 of the side cover 12 of the insulating housing 1, respectively. The two corresponding structures of the crimping terminal 3 pass through the penetrating groove 121 of the main body 110 of the shell 11 of the insulating housing 1 and the penetrating groove 121 of the side cover 12 of the insulating housing 1, and then the two corresponding structures of the crimping terminal 3 are disposed in the two fastening grooves 24. Front ends of the inner surfaces of the two extending arms 22 extend inward to form the two pivoting portions 25. The two pivoting portions 25 are mounted in the two pivoting holes 19 of the insulating housing 1.

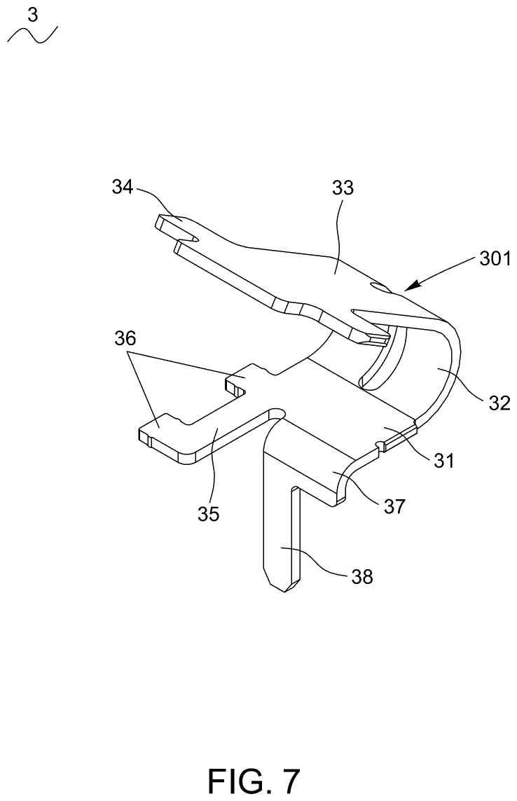

Referring to FIG. 2, FIG. 5 and FIG. 7, the crimping terminal 3 has a base portion 31, a clamping unit 301, a first extending portion 35, two first assembling portions 36, a second bending piece 37 and a first soldering portion 38. A front end of the base portion 31 is curved rearward to form a clamping unit 301. The clamping unit 301 has a first bending piece 32, a clamping portion 33 and two wings 34. A rear end of the base portion 31 extends downward to form the first soldering portion 38. The base portion 31 is disposed in the first inserting slot 1121. The clamping unit 301 is mounted in the front terminal slot 14. The clamping unit 301 is connected to the movable element 2. The front end of the base portion 31 is bent upward to form the first bending piece 32. A top end of the first bending piece 32 slantwise extends rearward and upward to form the clamping portion 33. Two opposite sides of the clamping portion 33 extend outward to form the two wings 34. The two wings 34 pass through the penetrating groove 121 of the main body 110 of the shell 11 of the insulating housing 1 and the penetrating groove 121 of the side cover 12 of the insulating housing 1, respectively, and then the two wings 34 are disposed in the two fastening grooves 24 of the movable element 2.

One side of the rear end of the base portion 31 extends rearward to form the first extending portion 35. A front end and a rear end of one side of the first extending portion 35 extend sideward and towards the side portion 115 of the shell 11 of the insulating housing 1 to form the two first assembling portions 36. The two first assembling portions 36 are fastened in two assembling holes 118 of the shell 11 of the insulating housing 1 which are formed at a front end of the insulating housing 1 to realize that the crimping terminal 3 is located to the insulating housing 1, and that the crimping terminal 3 is fastened to the insulating housing 1. The other side of the rear end of the base portion 31 is bent downward to form the second bending piece 37. A bottom end of the second bending piece 37 extends downward to form the first soldering portion 38. The first soldering portion 38 extends out of the inserting slot 1125 which is communicated with the bottom of the front terminal slot 14. The first soldering portion 38 extends out of the first inserting slot 1121 of the bottom portion 112 of the shell 11 of the insulating housing 1. The first soldering portion 38 is inserted into a corresponding place of the circuit board 6.

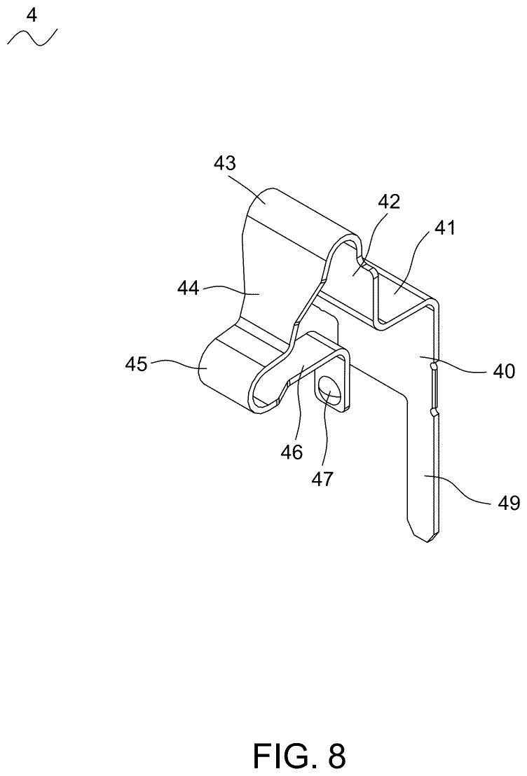

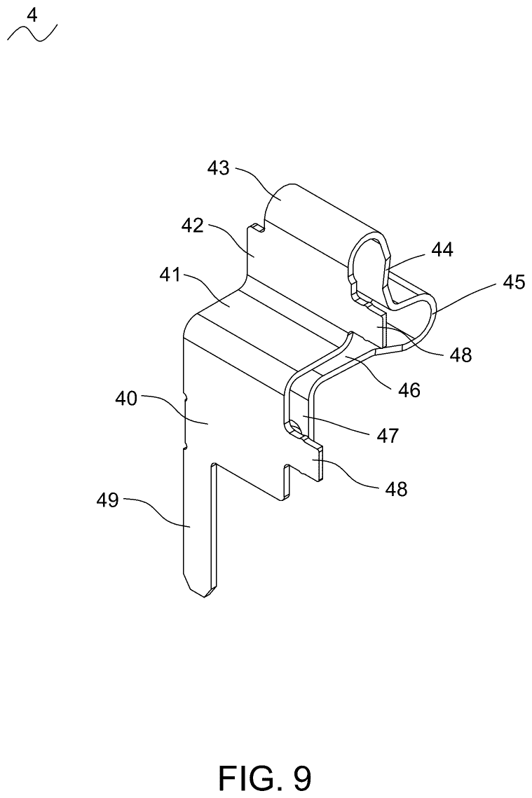

Referring to FIG. 8 and FIG. 9, the first signal terminal 4 has a first fastening portion 40, a second extending portion 41, a third extending portion 42, a first bending portion 43, a connecting portion 44, an abutting portion 45, a fourth extending portion 46, a first contacting portion 47, two second assembling portions 48 and a second soldering portion 49.

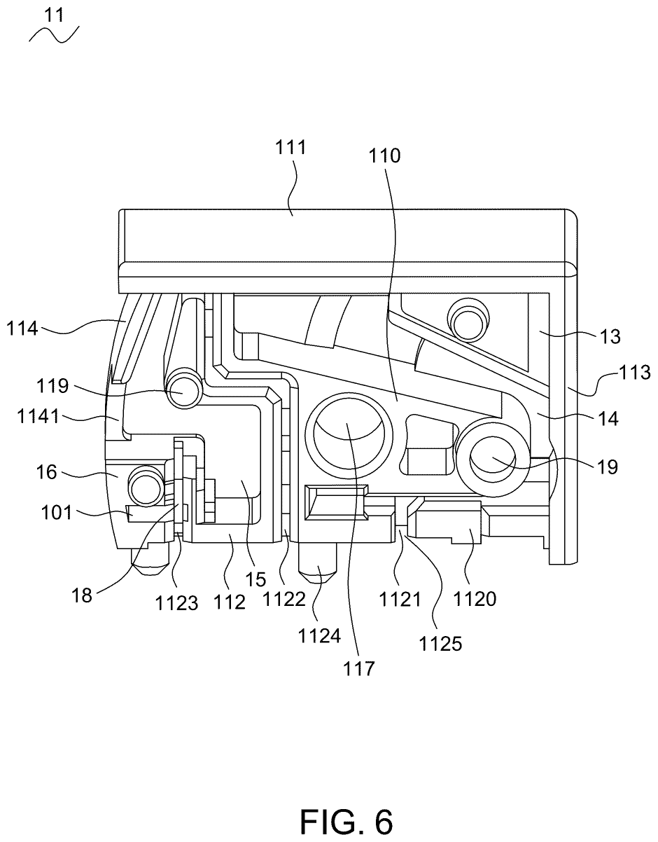

Referring to FIG. 2, FIG. 6, FIG. 8 and FIG. 9, a top end of the first fastening portion 40 extends rearward to form the first contacting portion 47. The top end of the first fastening portion 40 extends rearward to form the second extending portion 41. A rear end of the second extending portion 41 extends upward to form the third extending portion 42. A top end of the third extending portion 42 is bent rearward to form the first bending portion 43. A top end of the first bending portion 43 is arched upward. A rear end of the first bending portion 43 slantwise extends downward and rearward to form the connecting portion 44. A rear end of the connecting portion 44 is bent downward to form the abutting portion 45. A rear end of the abutting portion 45 is arched rearward. The abutting portion 45 is disposed to the rear hole 1141 of the rear portion 114 of the shell 11 of the insulating housing 1. A front end of the abutting portion 45 extends frontward to form the fourth extending portion 46. A front end of the fourth extending portion 46 extends downward to form the first contacting portion 47. The first contacting portion 47 contacts with a corresponding zone of the second signal terminal 5.

Referring to FIG. 5, FIG. 6, FIG. 8 and FIG. 9, one side of the first fastening portion 40 extends towards the side portion 115 of the shell 11 of the insulating housing 1 to form one second assembling portion 48. One side of the third extending portion 42 extends towards the side portion 115 of the shell 11 of the insulating housing 1 to form the other second assembling portion 48. The first fastening portion 40 is disposed to the second inserting slot 1122. The first contacting portion 47 is disposed in the rear terminal slot 15. The two second assembling portions 48 are fastened in two assembling holes 118 of the shell 11 of the insulating housing 1 which are formed at a substantial middle of the shell 11 to realize that the first signal terminal 4 is located to the insulating housing 1, and that the first signal terminal 4 is fastened to the insulating housing 1. A bottom end of the first fastening portion 40 extends downward to form the second soldering portion 49. The second soldering portion 49 extends out of one inserting slot 1125 which is communicated with the rear terminal slot 15. The second soldering portion 49 extends out of the second inserting slot 1122 of the bottom portion 112 of the shell 11 of the insulating housing 1. The second soldering portion 49 is inserted into a corresponding region of the circuit board 6.

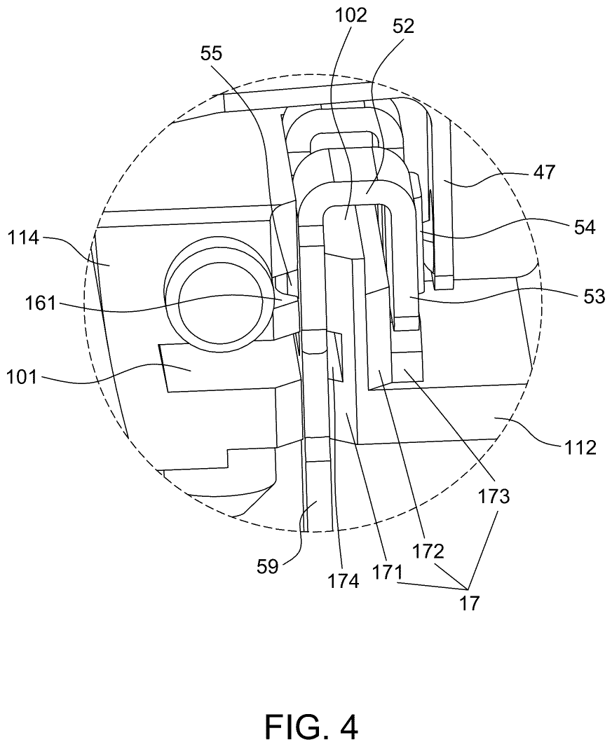

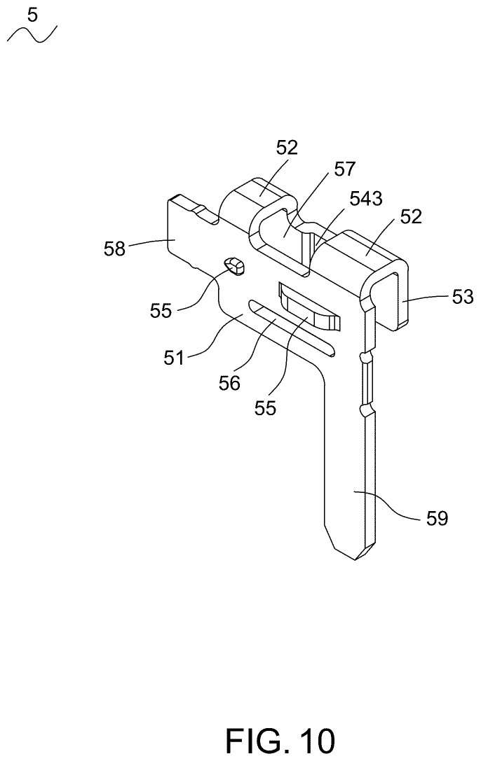

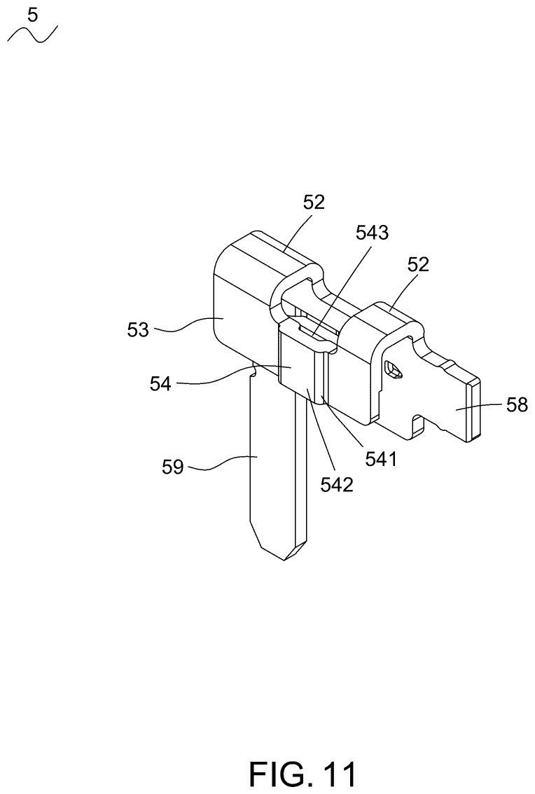

Referring to FIG. 4, FIG. 10 and FIG. 11, the second signal terminal 5 has a second fastening portion 51, a second bending portion 52, a second contacting portion 53, a protruding portion 54, a plurality of limiting blocks 55, an aperture 56, a perforation 57, a third assembling portion 58 and a third soldering portion 59.

Referring to FIG. 4 to FIG. 11, the second fastening portion 51 of the second signal terminal 5 is disposed in the gap 18 of the shell 11 of the insulating housing 1. The second fastening portion 51 is disposed to the third inserting slot 1123. A top end of the second fastening portion 51 is bent frontward to form the second bending portion 52. The second bending portion 52 is used for increasing a distance between the second contacting portion 53 and the third soldering portion 59. A front end of the second bending portion 52 extends downward to form the second contacting portion 53. The second contacting portion 53 is disposed in the rear terminal slot 15. A bottom end of the second contacting portion 53 abuts against the top surface of the third stepping portion 173 of the stepping portion 17 of the shell 11 of the insulating housing 1. A front surface of the third stepping portion 173 of the stepping portion 17 of the shell 11 of the insulating housing 1 is flush with a front surface of the second contacting portion 53. A rear surface of the second contacting portion 53 abuts against a front surface of the second stepping portion 172 of the stepping portion 17 of the shell 11 of the insulating housing 1. The second contacting portion 53 is corresponding to the first contacting portion 47. The second contacting portion 53 contacts with the first contacting portion 47. A middle of the front surface of the second contacting portion 53 extends frontward to form the protruding portion 54. The protruding portion 54 contacts with the first contacting portion 47 of the first signal terminal 4. The protruding portion 54 extends beyond the front surface of the third stepping portion 173 of the stepping portion 17 of the shell 11 of the insulating housing 1. The terminal block 100 has a contacting portion which includes the first contacting portion 47 and the second contacting portion 53.

The protruding portion 54 of the second signal terminal 5 has two curve portions 541 and a convex surface 542. The two curve portions 541 are formed at the front surface of the second contacting portion 53 of the second signal terminal 5. Two sides of the front surface of the second contacting portion 53 of the second signal terminal 5 extend frontward and then are bent sideways to form the two curve portions 541. The two curve portions 541 are disposed opposite to each other. Two facing ends of the two curve portions 541 extend towards each other to form the convex surface 542. The first contacting portion 47 of the first signal terminal 4 contacts with the convex surface 542. Inner surfaces of the two curve portions 541 and an inner surface of the convex surface 542 together form an inner space 543. The inner space 543 of the protruding portion 54 of the second signal terminal 5 is used for increasing a rear space of the second contacting portion 53. The protruding portion 54 is used for receiving the soldering flux. The inner space 543 is formed between the rear surface of the second contacting portion 53 and a rear surface of the protruding portion 54.

The top surface of the bottom portion 112 of the shell 11 of the insulating housing 1, the front surface of the rear portion 114 of the shell 11 of the insulating housing 1, a bottom surface of the limiting portion 16 of the shell 11 of the insulating housing 1 and a rear surface of the second fastening portion 51 of the second signal terminal 5 together surround an accommodating space 101. The accommodating space 101 is used for increasing the storage space of the soldering flux and reducing the climbing height of the soldering flux.

The first stepping portion 171 of the stepping portion 17 of the shell 11 of the insulating housing 1, the second stepping portion 172 of the stepping portion 17 of the shell 11 of the insulating housing 1, the second bending portion 52 of the second signal terminal 5, the second contacting portion 53 of the second signal terminal 5 and the inner space 543 of the protruding portion 54 of the second signal terminal 5 together surround an avoiding space 102. The soldering flux climbs along the rear surface of the second contacting portion 53 by the avoiding space 102.

The rear surface of the second fastening portion 51 extends rearward to form the plurality of the limiting blocks 55. The plurality of the limiting blocks 55 are fastened in the limiting groove 161 of the limiting portion 16 of the shell 11 of the insulating housing 1 to realize that the second signal terminal 5 is located to the insulating housing 1, and that the second signal terminal 5 is fastened to the insulating housing 1. The aperture 56 penetrates through a front surface and the rear surface of the second fastening portion 51. The aperture 56 is corresponding to the gap 18 of the shell 11 of the insulating housing 1. The aperture 56 is corresponding to the accommodating space 101 and the notch 174 of the stepping portion 17 of the shell 11 of the insulating housing 1.

The insulating housing 1 has at least one of the notch 174 and the accommodating space 101 which are communicated with the aperture 56. The notch 174 is formed in a front wall of the third inserting slot 1123. The accommodating space 101 is formed in a rear wall of the third inserting slot 1123. Preferably, the insulating housing 1 has the notch 174 and the accommodating space 101. The aperture 56 is located between the accommodating space 101 and the notch 174 of the stepping portion 17 of the shell 11 of the insulating housing 1. The aperture 56 is communicated with the accommodating space 101 and the notch 174 of the stepping portion 17 of the shell 11 of the insulating housing 1. The aperture 56 and the notch 174 are used for increasing the storage space of the soldering flux and reducing the climbing height of the soldering flux.

In the preferred embodiment, a front of a lower portion of the gap 18 extends frontward to form the notch 174. A rear of the lower portion of the gap 18 extends rearward to form the accommodating space 101.

The perforation 57 penetrates through middles of a top surface and a bottom surface of the second bending portion 52. The perforation 57 is corresponding to the protruding portion 54. The perforation 57 is communicated with the avoiding space 102. The perforation 57 is used for preventing the soldering flux flowing between the first contacting portion 47 of the first signal terminal 4 and the protruding portion 54 of the second signal terminal 5.

One side of the second fastening portion 51 extends towards the side portion 115 of the shell 11 of the insulating housing 1 to form the third assembling portion 58. The third assembling portion 58 is fastened in the assembling hole 118 of the shell 11 of the insulating housing 1 which is formed at a rear end of the shell 11 to realize that the second signal terminal 5 is located to the insulating housing 1, and that the second signal terminal 5 is fastened to the insulating housing 1. A bottom end of the second fastening portion 51 extends downward to form the third soldering portion 59. The third soldering portion 59 extends out of the gap 18 and the other inserting slot 1125 which is communicated with the rear terminal slot 15. The third soldering portion 59 extends out of the gap 18 of the shell 11 of the insulating housing 1 and the third inserting slot 1123 of the bottom portion 112 of the shell 11 of the insulating housing 1. The third soldering portion 59 is inserted into a corresponding position of the circuit board 6.

Referring to FIG. 2 to FIG. 11, the circuit board 6 has a first through hole 61, a second through hole 62, a third through hole 63 and at least one third location hole 64. In the preferred embodiment, the circuit board 6 has two third location holes 64. The first through hole 61 penetrates through a top surface and a bottom surface of the circuit board 6. The second through hole 62 penetrates through the top surface and the bottom surface of the circuit board 6. The third through hole 63 penetrates through the top surface and the bottom surface of the circuit board 6. The first soldering portion 38 of the crimping terminal 3 is inserted into the first through hole 61. The second soldering portion 49 of the first signal terminal 4 is inserted into the second through hole 62. The third soldering portion 59 of the second signal terminal 5 is inserted into the third through hole 63. The two third location holes 64 penetrate through the top surface and the bottom surface of the circuit board 6. The two third location pillars 1124 of the bottom portion 112 of the shell 11 of the insulating housing 1 are fastened to the two third location holes 64 to realize that the insulating housing 1 is located to the circuit board 6, and that the insulating housing 1 is fastened to the circuit board 6. In the preferred embodiment, the circuit board 6 has a plurality of through holes 65 penetrating through the top surface and the bottom surface of the circuit board 6. The first through hole 61, the second through hole 62 and the third through hole 63 together form the plurality of the through holes 65. The plurality of the through holes 65 include the first through hole 61, the second through hole 62 and the third through hole 63. The first soldering portion 38, the second soldering portion 49 and the third soldering portion 59 are inserted into the plurality of the through holes 65 separately.

The second soldering portion 49 of the first signal terminal 4 is inserted into the second through hole 62, and the third soldering portion 59 of the second signal terminal 5 is inserted into the third through hole 63, so the first signal terminal 4, the second signal terminal 5 and the circuit board 6 form a signal circuit. When the pressing portion 21 of the movable element 2 is without being pressed, the first contacting portion 47 of the first signal terminal 4 and the protruding portion 54 of the second signal terminal 5 contact with each other, so the signal circuit of the terminal block 100 is conductive, and the signal circuit of the terminal block 100 remains in a conductive path state.

Before a wire (not shown) is inserted into the passage hole 1131 of the insulating housing 1, the pressing portion 21 of the movable element 2 is pressed in advance, so that the movable element 2 rotates downward with respect to the insulating housing 1.

When the pressing portion 21 of the movable element 2 is pressed, the movable element 2 rotates downward with respect to the insulating housing 1. When the movable element 2 is rotated, the two wings 34 of the crimping terminal 3 are disposed in the two fastening grooves 24 of the movable element 2. In a rotating process, the clamping portion 33 of the crimping terminal 3 moves towards the base portion 31 of the crimping terminal 3. An upper space which is located to a top of the clamping portion 33 of the crimping terminal 3 is vacated.

After a cable (not shown) passes through the passage hole 1131 of the front portion 113 of the shell 11 of the insulating housing 1, the cable (not shown) enters the wire slot 13. The cable (not shown) is able to continue to penetrate into the upper space of the clamping portion 33 of the crimping terminal 3. The cable (not shown) is clamped between the crimping terminal 3 and an upper wall of the front terminal slot 14 by an upward pressure which is exerted by the clamping portion 33 of the crimping terminal 3, and the cable is electrically connected with the crimping terminal 3 by the upward pressure which is exerted by the clamping portion 33 of the crimping terminal 3. The cable (not shown) which is exposed outside is hidden in the insulating housing 1.

When the pressing portion 21 of the movable element 2 is pressed, the protrusion block 23 of the movable element 2 presses against the abutting portion 45 of the first signal terminal 4, so the abutting portion 45 of the first signal terminal 4 is pressed to drive the fourth extending portion 46 of the first signal terminal 4 and the first contacting portion 47 of the first signal terminal 4 to move forward. The first contacting portion 47 of the first signal terminal 4 moves away from the protruding portion 54 of the second signal terminal 5. The first contacting portion 47 of the first signal terminal 4 and the protruding portion 54 of the second signal terminal 5 are without contacting mutually, so the terminal block 100 remains in an open circuit state. The cable (not shown) is inserted into the terminal block 100 by the open circuit state.

As described above, the top end of the second fastening portion 51 is bent frontward to form the second bending portion 52, and the second bending portion 52 is used for increasing the distance between the second contacting portion 53 and the third soldering portion 59. The front surface of the second contacting portion 53 extends frontward to form the protruding portion 54, the inner space 543 of the protruding portion 54 of the second signal terminal 5 is used for increasing the rear space of the second contacting portion 53, and the protruding portion 54 is used for receiving the soldering flux. The bottom portion 112 of the shell 11 of the insulating housing 1, the rear portion 114 of the shell 11 of the insulating housing 1, the limiting portion 16 of the shell 11 of the insulating housing 1 and the second fastening portion 51 of the second signal terminal 5 together surround the accommodating space 101, and the accommodating space 101 is used for increasing the storage space of the soldering flux and reducing the climbing height of the soldering flux. The aperture 56 penetrates through the front surface and the rear surface of the second fastening portion 51. The aperture 56 is corresponding to the accommodating space 101 and the notch 174 of the stepping portion 17 of the shell 11 of the insulating housing 1. The aperture 56 is communicated with the accommodating space 101 and the notch 174 of the stepping portion 17 of the shell 11 of the insulating housing 1. The aperture 56 and the notch 174 of the stepping portion 17 of the shell 11 of the insulating housing 1 are used for increasing the storage space of the soldering flux and reducing the climbing height of the soldering flux. The perforation 57 penetrates through the middles of the top surface and the bottom surface of the second bending portion 52. The perforation 57 is used for preventing the soldering flux flowing between the first contacting portion 47 of the first signal terminal 4 and the protruding portion 54 of the second signal terminal 5. The first stepping portion 171 of the stepping portion 17 of the shell 11 of the insulating housing 1, the second stepping portion 172 of the stepping portion 17 of the shell 11 of the insulating housing 1, the second bending portion 52 of the second signal terminal 5, the second contacting portion 53 of the second signal terminal 5 and the inner space 543 of the protruding portion 54 of the second signal terminal 5 together form the avoiding space 102. The soldering flux climbs along the rear surface of the second contacting portion 53 by the avoiding space 102. As a result, the terminal block 100 prevents the soldering flux from contaminating the contacting portion of the terminal block 100 in a soldering process of the terminal block 100.

What is claimed is:

1. A terminal block, comprising:
an insulating housing having a front terminal slot, a rear terminal slot and a bottom portion, the bottom portion of the insulating housing having a plurality of inserting slots, the plurality of the inserting slots being communicated with the front terminal slot and the rear terminal slot, respectively;
a movable element disposed to a rear end of the insulating housing;
a crimping terminal disposed in the front terminal slot, the crimping terminal having a first soldering portion, the first soldering portion extending out of the inserting slot which is communicated with the front terminal slot;
a first signal terminal disposed in the rear terminal slot, the first signal terminal being disposed to a rear of the crimping terminal, the first signal terminal having a first fastening portion, a top end of the first fastening portion extending rearward to form a first contacting portion, a bottom end of the first fastening portion extending downward to form a second soldering portion, the second soldering portion extending out of one inserting slot which is communicated with the rear terminal slot;
a second signal terminal disposed in the rear terminal slot, the second signal terminal being disposed to a rear of the first signal terminal, the second signal terminal having a second fastening portion, a top end of the second fastening portion being bent frontward to form a second bending portion, the second bending portion extending downward to form a second contacting portion, a front surface of the second contacting portion extending frontward to form a protruding portion, the protruding portion contacting with the first contacting portion, an inner space being formed between a rear surface of the second contacting portion and a rear surface of the protruding portion, a bottom end of the second fastening portion extending downward to form a third soldering portion, the third soldering portion extending out of the other inserting slot which is communicated with the rear terminal slot; and
a circuit board disposed to a bottom surface of the insulating housing, the circuit board having a plurality of through holes penetrating through a top surface and a bottom surface of the circuit board, the first soldering portion, the second soldering portion and the third soldering portion being inserted into the plurality of the through holes separately.

2. The terminal block as claimed in claim 1, wherein the protruding portion of the second signal terminal has two curve portions and a convex surface, two sides of the front surface of the second contacting portion of the second signal terminal extend frontward and then are bent sideways to form the two curve portions, the two curve portions are disposed opposite to each other, two facing ends of the two curve portions extend towards each other to form the convex surface, the first contacting portion of the first signal terminal contacts with the convex surface, inner surfaces of the two curve portions and an inner surface of the convex surface together form the inner space.

3. The terminal block as claimed in claim 2, wherein a top surface of the bottom portion of the insulating housing extends upward to form a stepping portion, the stepping portion has a first stepping portion, a second stepping portion and a third stepping portion, the top surface of the bottom portion of the insulating housing extends upward to form the first stepping portion, the second stepping portion and the third stepping portion in sequence, the second stepping portion is disposed to a front end of the first stepping portion, the third stepping portion is disposed to a front end of the second stepping portion, the first stepping portion and the second stepping portion are clamped by the second signal terminal, a bottom end of the second contacting portion abuts against a top surface of the third stepping portion, a front surface of the third stepping portion is flush with the front surface of the second contacting portion, the protruding portion extends beyond the front surface of the third stepping portion.

4. The terminal block as claimed in claim 3, wherein the insulating housing has a rear portion, a lower portion of the rear portion extends frontward to form a limiting portion, a gap of the insulating housing is formed between a front surface of the limiting portion and a rear surface of the first stepping portion of the stepping portion of the insulating housing, the second fastening portion of the second signal terminal is disposed in the gap, the third soldering portion extends out of the gap and the other inserting slot which is communicated with the rear terminal slot.

5. The terminal block as claimed in claim 4, wherein the crimping terminal has a base portion, one side of a rear end of the base portion extends rearward to form a first extending portion, a front end and a rear end of one side of the first extending portion extend sideward to form two first assembling portions, the two first assembling portions are fastened in two assembling holes which are formed at a front end of the insulating housing.

6. The terminal block as claimed in claim 5, wherein the front surface of the limiting portion is recessed rearward to form a limiting groove, a rear surface of the second fastening portion extends rearward to form a plurality of limiting blocks, the plurality of the limiting blocks are fastened in the limiting groove, the top end of the first fastening portion extends rearward to form a second extending portion, a rear end of the second extending portion extends upward to form a third extending portion, a top end of the third extending portion is bent rearward to form a first bending portion, a rear end of the first bending portion slantwise extends downward and rearward to form a connecting portion, a rear end of the connecting portion is bent downward to form an abutting portion, a front end of the abutting portion extends frontward to form a fourth extending portion, a front end of the fourth extending portion extends downward to form the first contacting portion, the insulating housing has a rear hole penetrating through an outer surface of the rear portion, a front surface of the rear portion and a rear surface of the rear portion, the limiting portion is located below the rear hole, the abutting portion is disposed to the rear hole.

7. The terminal block as claimed in claim 4, wherein the bottom portion of the insulating housing, the rear portion of the insulating housing, the limiting portion of the insulating housing and the second fastening portion of the second signal terminal together surround an accommodating space.

8. The terminal block as claimed in claim 7, wherein a rear surface of the first stepping portion is recessed frontward to form a notch, the second signal terminal has an aperture penetrating through a front surface and a rear surface of the second fastening portion, the aperture is corresponding to the gap of the insulating housing, the aperture is corresponding to the accommodating space and the notch of the stepping portion of the insulating housing, the aperture is communicated with the accommodating space and the notch of the stepping portion of the insulating housing.

9. The terminal block as claimed in claim 4, wherein the plurality of the inserting slots include a first inserting slot, a second inserting slot and a third inserting slot, the first inserting slot penetrates through the top surface and a bottom surface of the bottom portion of the insulating housing, the second inserting slot penetrates through the top surface and the bottom surface of the bottom portion of the insulating housing, the third inserting slot penetrates through the top surface and the bottom surface of the bottom portion of the insulating housing, the crimping terminal is disposed in the first inserting slot, the first soldering portion extends out of the first inserting slot, the first signal terminal is disposed in the second inserting slot, the second soldering portion extends out of the second inserting slot, the second signal terminal is disposed in the third inserting slot, the third soldering portion extends out of the third inserting slot, the gap of the insulating housing is communicated with the third inserting slot.

10. The terminal block as claimed in claim 3, wherein the first stepping portion of the stepping portion of the insulating housing, the second stepping portion of the stepping portion of the insulating housing, the second bending portion of the second signal terminal, the second contacting portion of the second signal terminal and the inner space of the protruding portion of the second signal terminal together surround an avoiding space.

11. The terminal block as claimed in claim 10, wherein the second signal terminal has a perforation penetrating through middles of a top surface and a bottom surface of the second bending portion, the perforation is corresponding to the protruding portion, the perforation is communicated with the avoiding space.

12. The terminal block as claimed in claim 1, wherein the plurality of the through holes include a first through hole, a second through hole and a third through hole, the first through hole penetrates through the top surface and the bottom surface of the circuit board, the second through hole penetrates through the top surface and the bottom surface of the circuit board, the third through hole penetrates through the top surface and the bottom surface of the circuit board, the first soldering portion of the crimping terminal is inserted into the first through hole, the second soldering portion of the first signal terminal is inserted into the second through hole, the third soldering portion of the second signal terminal is inserted into the third through hole.

13. A terminal block, comprising:
an insulating housing having a bottom portion, the bottom portion having at least one inserting slot which penetrates through the bottom portion;
a crimping terminal disposed in the insulating housing; and
at least one signal terminal disposed in the insulating housing, the signal terminal being disposed to a rear of the crimping terminal, the signal terminal having a fastening portion, a contacting portion and a soldering portion, the fastening portion being disposed to the inserting slot, the soldering portion extending out of the inserting slot,
wherein the signal terminal has an aperture penetrating through a front surface and a rear surface of the fastening portion, and
wherein the insulating housing has at least one of a notch and an accommodating space which are communicated with the aperture, the notch is formed in a front wall of the inserting slot, the accommodating space is formed in a rear wall of the inserting slot.

14. The terminal block as claimed in claim 13, wherein a top surface of the bottom portion of the insulating housing extends upward to form a stepping portion, the stepping portion has a first stepping portion, a second stepping portion and a third stepping portion, the top surface of the bottom portion of the insulating housing extends upward to form the first stepping portion, the second stepping portion and the third stepping portion in sequence, the second stepping portion is disposed to a front end of the first stepping portion, the third stepping portion is disposed to a front end of the second stepping portion, the first stepping portion and the second stepping portion are clamped by the signal terminal, a bottom end of the contacting portion abuts against a top surface of the third stepping portion, a front surface of the third stepping portion is flush with a front surface of the contacting portion.

15. The terminal block as claimed in claim 14, wherein a rear surface of the first stepping portion of the insulating housing is recessed frontward to form the notch, the aperture is corresponding to the notch of the stepping portion of the insulating housing, the aperture is communicated with the notch of the stepping portion of the insulating housing.

16. The terminal block as claimed in claim 14, wherein the insulating housing has a rear portion, a lower portion of the rear portion extends frontward to form a limiting portion, the inserting slot is formed between a front surface of the limiting portion and a rear surface of the first stepping portion of the stepping portion of the insulating housing, the fastening portion of the signal terminal is disposed in the inserting slot, the soldering portion extends out of the inserting slot.

17. The terminal block as claimed in claim 16, wherein the bottom portion of the insulating housing, the rear portion of the insulating housing, the limiting portion of the insulating housing and the fastening portion of the signal terminal together surround an accommodating space.

18. The terminal block as claimed in claim 13, wherein a front surface of the contacting portion extends frontward to form a protruding portion, an inner space is formed between a rear surface of the contacting portion and a rear surface of the protruding portion.

19. The terminal block as claimed in claim 18, wherein the protruding portion of the signal terminal has two curve portions and a convex surface, two sides of the front surface of the contacting portion of the signal terminal extend frontward and then are bent sideways to form the two curve portions, the two curve portions are disposed opposite to each other, two facing ends of the two curve portions extend towards each other to form the convex surface, inner surfaces of the two curve portions and an inner surface of the convex surface together form the inner space.

20. A terminal block, comprising:
an insulating housing having a front terminal slot, a rear terminal slot and a bottom portion, the bottom portion having a first inserting slot, a second inserting slot and a third inserting slot which penetrate through a bottom surface of the bottom portion, the front terminal slot being communicated with the first inserting slot, the rear terminal slot being communicated with the second inserting slot and the third inserting slot;
a movable element disposed to a rear end of the insulating housing;
a crimping terminal disposed in the front terminal slot, the crimping terminal having a base portion, a rear end of the base portion extending downward to form a first soldering portion, the base portion being disposed in the first inserting slot, the first soldering portion extending out of the first inserting slot;
a first signal terminal disposed in the rear terminal slot, the first signal terminal being disposed to a rear of the crimping terminal, the first signal terminal having a first fastening portion, a top end of the first fastening portion extending rearward to form a first contacting portion, a bottom end of the first fastening portion extending downward to form a second soldering portion, the first contacting portion being disposed in the rear terminal slot, the second soldering portion extending out of the second inserting slot;
a second signal terminal disposed in the rear terminal slot, the second signal terminal being disposed to a rear of the first signal terminal, the second signal terminal having a second fastening portion, a top end of the second fastening portion being bent frontward to form a second bending portion, the second bending portion extending downward to form a second contacting portion, a front surface of the second contacting portion extending frontward to form a protruding portion, the protruding portion contacting with the first contacting portion, a perforation penetrating through middles of a top surface and a bottom surface of the second bending portion, the perforation being corresponding to the protruding portion, a bottom end of the second fastening portion extending downward to form a third soldering portion, the third soldering portion extending out of the third inserting slot.
